(19) United States
(12) Patent Application Publication
(10) Pub. No.: US 2009/0297905 A1
(43) Pub. Date: Dec. 3, 2009

(54) Large Cathode Membrane Electrode Assembly

(76) Inventor: Agota F. Fehervari, Lexington, MA (US)

Correspondence Address: Bose Corporation;c/o Donna Griffiths, The Mountain, MS 40, IP Legal - Patent Support, Framingham, MA, 01701, US

(21) Appl. No.: 12/129,184

(22) Filed: May 29, 2008

(51) Int. Cl. H01M 8/10

(52) U.S. Cl. 429/30

(57) ABSTRACT

A membrane electrode assembly includes a polymer electrolyte membrane sandwiched between an anode catalyst layer and a cathode catalyst layer. The area of the anode catalyst layer is less than the area of the cathode catalyst layer. The larger cathode catalyst layer is believed to increase collection of protons from the anode reaction, reduce the corrosive effect of the highly acidic solvated protons in the polymer electrolyte membrane, and allow for small misalignments of the layers during construction of the assembly.

### BACKGROUND

The present invention relates to fuel cells and more specifically to membrane electrode assemblies for polymer electrolyte fuel cells.

In a polymer electrolyte fuel cell (PEFC), an electrically non-conducting, proton permeable polymer electrolyte membrane (PEM) separates the anode and cathode of the fuel cell. On the anode side of the fuel cell, fuel is oxidized to produce protons and electrons when the fuel is hydrogen. If the fuel is a hydrocarbon derivative or a functionalized hydrocarbon such as methanol or ethanol, for example, the fuel is oxidized to form protons, electrons, and carbon dioxide. The protons are driven through the PEM to the cathode. On the cathode side of the fuel cell, protons passing through the PEM are combined with oxygen atoms and electrons to form water.

If unreacted fuel reaches the cathode side of the fuel cell, the efficiency of the fuel cell decreases because unreacted fuel does not contribute to the power output of the cell. Furthermore, the fuel can be oxidized at the cathode and may also flood the cathode-side catalyst. Unreacted fuel may reach the cathode by diffusing through the PEM, which is usually referred to as crossover.

Unreacted fuel may also reach the cathode by leaking around the membrane electrode assembly (MEA), which includes the PEM, an electrocatalyst, and a diffusion layer. The MEA may be sealed to the fuel cell housing a gasket to prevent fuel leakage around the MEA. An example of such a gasket is disclosed in co-pending application Ser. No. 11/609,593 filed Dec. 12, 2006, herein incorporated by reference in its entirety.

### SUMMARY

A membrane electrode assembly includes a polymer electrolyte membrane sandwiched between an anode catalyst layer and a cathode catalyst layer. The area of the anode catalyst layer is less than the area of the cathode catalyst layer. The larger cathode catalyst layer is believed to increase collection of protons from the anode reaction, reduce the corrosive effect of the highly acidic solvated protons in the polymer electrolyte membrane, and allow for small misalignments of the layers during construction of the assembly.

One embodiment of the present invention is directed to a membrane electrode assembly comprising: a polymer electrolyte membrane having an anode side and a cathode side; an anode in contact with the anode side of the polymer electrolyte membrane, the anode characterized by an anode area; and a cathode in contact with the cathode side of the polymer electrolyte membrane, the cathode characterized by a cathode area, wherein the cathode area is greater than the anode area.

Another embodiment of the present invention is directed to a membrane electrode assembly comprising: a polymer electrolyte membrane having an anode side and a cathode side; an anode in contact with the anode side of the polymer electrolyte membrane, the anode characterized by an edge; and a cathode in contact with the cathode side of the polymer electrolyte membrane, the cathode sized to extend beyond a portion of the edge. In an aspect, the cathode is sized to extend beyond every portion of the edge.

### BRIEF DESCRIPTION OF THE DRAWINGS

FIG. 1 is a sectional view illustrating an embodiment of the present invention

FIG. 2a is a diagram illustrating a sectional view of another embodiment of the present invention;

FIG. 2b is a plan view of the embodiment shown in FIG. 2a; and

FIG. 3 is a diagram illustrating a misaligned anode relative to a cathode.

FIG. 4 is a graph illustrating an effect of a large cathode on fuel cell performance.

### DETAILED DESCRIPTION

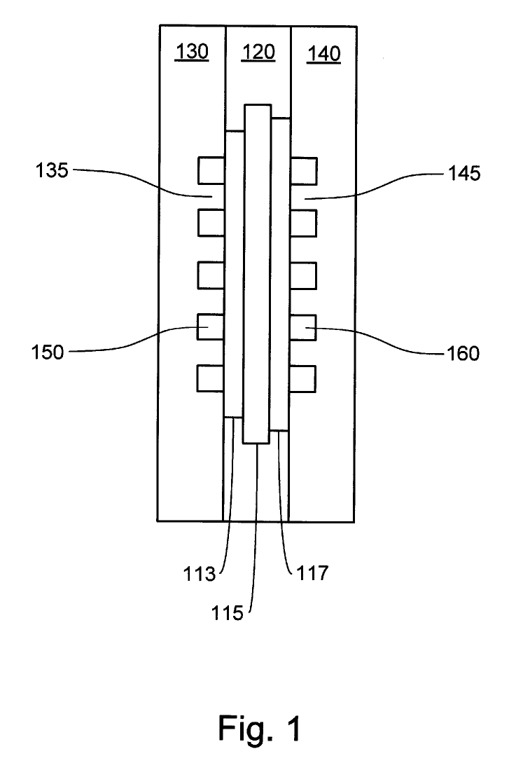

In FIG. 1, a MEA is supported by a gasket 120. The MEA includes a PEM 115 between an anode 113 and a cathode 117. A fuel distributor 130 delivers fuel such as hydrogen or methanol, for example, to the anode 113 via channels 150. The fuel is oxidized at the anode releasing electrons and protons. The protons diffuse through the PEM 115 to the cathode 117. The electrons are transferred from the anode 113 through ridges 135 in contact with the anode and extracted through the electrically conductive fuel distributor 130.

A gas distributor 140 distributes an oxidizer gas to the cathode 117 of the fuel cell. Ridges 145 in the gas distributor 140 are in electrical contact with the cathode and provide a conductive path for electrons to reach the cathode where they react with the oxidizer gas and protons to form water. The ridges 145 define channels 160 delivering the oxidizer gas to the cathode. The oxidizer gas may be pure oxygen or a mixture of oxygen and other gases such as, for example, air. The water content or humidity of the oxidizer gas may be externally humidified or internally humidified. An example of a gas distributor with internal humidification is disclosed in co-pending application Ser. No. 11/746,426 filed May 9, 2007, herein incorporated by reference in its entirety.

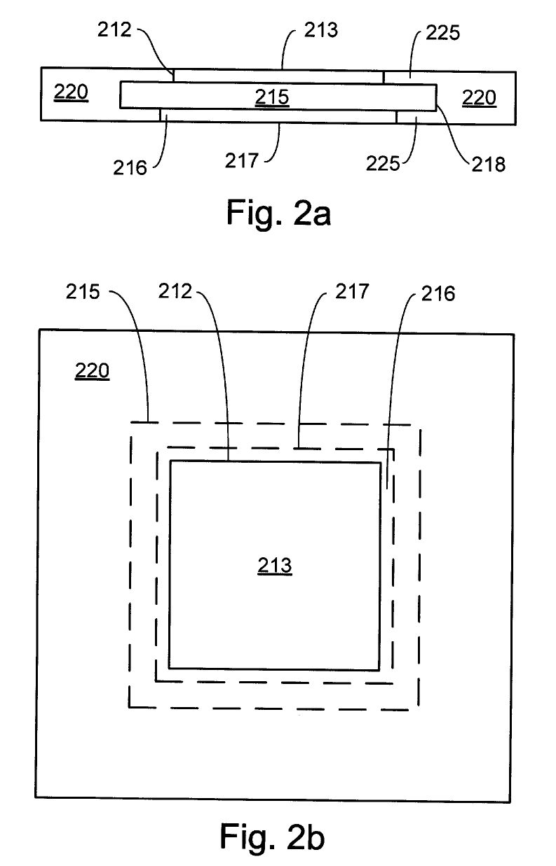

FIG. 2a is a sectional view of a MEA/gasket assembly and FIG. 2b is a plan view of the MEA/gasket assembly shown in FIG. 2a. In FIG. 2a, the anode 213 is sized to be smaller than the cathode 217 such that a portion 216 of the cathode 217 overlaps or extends beyond the edge 212 of the anode 213. In some embodiments, the cathode may extend beyond the anode over a portion of the edge 212. Both the anode 213 and cathode 217 are sized to be smaller than the PEM 215 thereby leaving an outer portion 225 of the PEM 215 exposed. A gasket 220 overlaps the exposed PEM portion 225 and seals the anode side of the MEA from the cathode side of the MEA.

The anode 213 preferably includes catalyst particles such as, for example, platinum/ruthenium particles supported on a porous conductive support such as, for example, carbon paper. The cathode 217 preferably includes catalyst particles such as, for example, platinum particles support on a porous conductive support such as, for example, carbon paper. The porous network of the porous conductive support provides a transport path to the anode and cathode catalyst particles for fuel and oxygen, respectively.

Without being limiting, it is believed that the larger cathode captures more of the protons permeating through the PEM and may reduce the acidity of the PEM near the edges of both the anode and cathode, thereby reducing the corrosive effect of the PEM on the surrounding gasket. Although the larger capture fraction of protons by the large cathode increases the energy produced by the fuel cell, the energy density may be decreased when based on the larger area of the cathode. Furthermore, increasing the cathode size may add to the cost of the cathode if additional catalyst is used in the larger cathode.

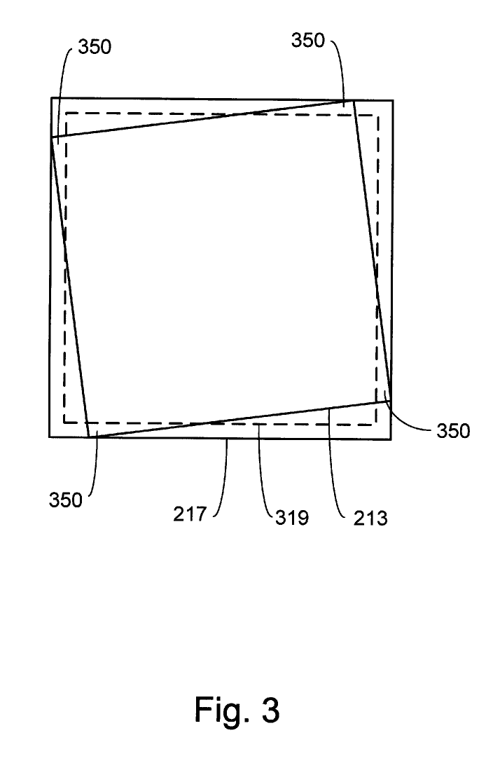

FIG. 3 illustrates a configuration where the anode 213 is not perfectly registered with the underlying larger cathode 217. In FIG. 3, the anode 213 is rotated relative to the cathode 217 but does not overlap or extend beyond the cathode. Although FIG. 3 illustrates an example where the anode-cathode misalignment is due to a rotation, other types of misalignments such as, for example, vertical or horizontal translation of the anode with respect to the cathode or combinations thereof are intended to be within the scope of embodiments of the present invention. FIG. 3 also indicates that if the cathode is the same size as the anode, indicated by dashed square 319 in FIG. 3, the slight rotation of the anode relative to the cathode creates regions 350 where the anode 213 overlaps or extends beyond the edge of the same-sized cathode 319. The overlap regions 350 may represent a more severe corrosive environment due to the uncollected protons and may lead to premature gasket or MEA material failure.

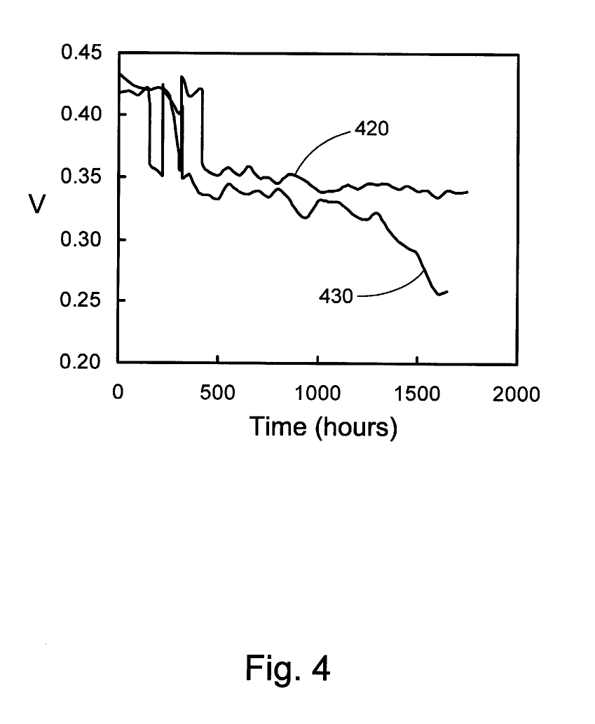

FIG. 4 illustrates an effect of a large cathode on fuel cell performance. In FIG. 4, the fuel cell voltage is plotted against time for a fuel cell having a large cathode and a fuel cell having a large anode, indicated by reference numbers 420 and 430, respectively. In the large cathode MEA, the PEM was sandwiched between a 44 mm×44 mm square cathode having a cathode area of about 19.4 cm² and a 42 mm×42 mm square anode having an anode area of about 17.6 cm². In the large anode MEA, the PEM was sandwiched between a 44 mm×44 mm square anode and a 42 mm×42 mm square cathode. The cathodes used a Pt catalyst at a platinum loading of about 3.05 mg/cm². The anodes used a Pt/Ru catalyst at a platinum loading of about 2.2 mg/cm². The PEM was a cross-linked, sulfonated styrene-isobutylene-styrene block copolymer (S-SIBS) prepared using the methods described in application Ser. No. 12/001,260 filed Dec. 11, 2007, herein incorporated by reference in its entirety. Although a cross-linked S-SIBS PEM was used in the example shown in FIG. 4, other types of polymer electrolyte membranes may be used in other embodiments. Each MEA was housed in an open anode fuel cell and operated at around 63° C. under load currents between about 2-3 A.

The large cathode fuel cell was operated under a load current of about 2 A and a series of V vs. I measurements were performed as indicated by the voltage swings during the first 500 hours of operation. The load current was increased to about 3 A and run for the duration of the experiment. As FIG. 4 indicates, the large cathode fuel cell voltage 420 remained relatively constant at about 0.35 V between about 500 to about 1750 hours. The large anode fuel cell was also operated under an initial load current of about 2 A while a series of V vs. I measurements were performed. After the V vs. I measurements were performed, the large anode fuel cell was operated under a load current of about 3 A for the duration of the experiment. As FIG. 4 indicates, the large anode fuel cell voltage 430 began to decrease after about 1000 hours resulting in about a 23% drop in fuel cell voltage between 1000 hours and 1600 hours.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

1. A membrane electrode assembly comprising:
a polymer electrolyte membrane having an anode side and a cathode side, the polymer electrolyte membrane characterized by a PEM area;
an anode in contact with the anode side of the polymer electrolyte membrane, the anode characterized by an anode area; and
a cathode in contact with the cathode side of the polymer electrolyte membrane, the cathode characterized by a cathode area, wherein the cathode area is greater than the anode area, and wherein the PEM area is greater than both the anode area and the cathode area.

2. A membrane electrode assembly comprising:
a polymer electrolyte membrane having an anode side and a cathode side, the polymer electrolyte membrane characterized by a PEM edge;
an anode in contact with the anode side of the polymer electrolyte membrane, the anode characterized by an anode edge; and
a cathode in contact with the cathode side of the polymer electrolyte membrane, the cathode characterized by a cathode edge, the cathode sized such that at least a portion of the cathode edge extends beyond at least a portion of the anode edge, and the polymer electrolyte membrane sized such that at least a portion of the PEM edge extends beyond both at least a portion of the anode edge and at least a portion of the cathode edge.

3. The membrane electrode assembly of claim 2 wherein the cathode is sized such that every portion of the cathode edge extends beyond every portion of the anode edge, and the polymer electrolyte membrane is sized such that every portion of the PEM edge extends beyond both every portion of the anode edge and every portion of the cathode edge.

4. A fuel cell comprising the membrane electrode assembly of claim 1.
